(19) United States
(12) Patent Application Publication
(10) Pub. No.: US 2023/0126624 A1
(43) Pub. Date: Apr. 27, 2023

(54) DAMP-PROOF PILL BOX

(71) Applicant: E-LINK PLASTIC & METAL INDUSTRIAL CO., LTD., New Taipei City (TW)

(72) Inventor: Pin-Yang CHANG, New Taipei City (TW)

(21) Appl. No.: 17/510,441

(22) Filed: Oct. 26, 2021

(51) Int. Cl. A61J 1/03; A61J 7/00

(52) U.S. Cl. CPC A61J 1/03; A61J 7/0069

(57) ABSTRACT

A damp-proof pill box has a container, at least one lid, at least one lock tab, at least one seal ring, and at least one lock part. The container forms at least one storage compartment. The lid is connected to the container and is flippable relative to the container to cover or to open the storage compartment. The lock tab protrudes from an edge of the lid. The seal ring is mounted on an inner surface of the lid. The lock part is pivotally connected to the container. When the lid covers the storage compartment, the seal ring is clamped between the lid and the container, and abuts against a periphery of the opening of the storage compartment to seal the storage compartment. The lock part is capable of engaging with the lock tab to prevent the lid from flipping relative to the container.

### BACKGROUND OF THE INVENTION

### 1. Field of the Invention

The present invention relates to a portable pill organizer.

### 2. Description of the Prior Arts

A pill box has one or multiple independent storage compartments, and each storage compartment has an exclusive lid. Pills are stored in the storage compartment(s) according to prescribed dosage and frequencies of medications as a reminder to take correct doses of medications in compliance with prescription. For example, when the user has to take medication for 7 consecutive days, the medications can be organized using a 7-compartment pill box. Each time the user takes medication, the user flips open one of the compartment lids to take the medication stored inside.

However, a conventional pill box lacks any special design that prevents moisture from entering. As a result, the moisture from the surroundings easily enters into the storage compartments and causes the medications stored inside to deteriorate.

To overcome the shortcomings, the present invention provides a damp-proof pill box to mitigate or obviate the aforementioned problems.

### SUMMARY OF THE INVENTION

The main objective of the present invention is to provide a damp-proof pill box that prevents the organized drug from exposure to moisture.

The damp-proof pill box has a container, at least one lid, at least one lock tab, at least one seal ring, and at least one lock part. The container forms at least one storage compartment. Each of the at least one storage compartment has an opening. The at least one lid is connected to the container and is flippable relative to the container to cover or to open the at least one storage compartment. Each of the at least one lid has a lid-inner surface facing toward a respective one of the at least one storage compartment. Each of the at least one lock tab protrudes from an edge of a respective one of the at least one lid. Each of the at least one seal ring is mounted on the lid-inner surface of a respective one of the at least one lid. The at least one lock part is pivotally connected to the container. When the at least one lid covers the at least one storage compartment, the at least one seal ring is clamped between the at least one lid and the container, and abuts against at least one periphery defined around the at least one opening of the at least one storage compartment to seal the at least one storage compartment. The at least one lock part selectively engages with the at least one lock tab to prevent the at least one lid from flipping relative to the container.

The advantages of the damp-proof pill box are as below:

First, when the storage compartments are covered by the lids, the seal rings are clamped between the lids and the container, and the seal rings abut against the peripheries of the openings of the storage compartments to prevent moisture from the surroundings to enter into the storage compartments, thereby preventing medications stored in the storage compartments from exposure to moisture.

Second, when the storage compartments are covered by the lids, the lock parts on the container are capable of engaging with the lock tabs to firmly clamp the seal rings from opposite directions, ensuring that the seal rings tightly abut against peripheries of the openings of the storage compartments. As a result, the pill box is tightly sealed from moisture.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a damp-proof pill box in accordance with the present invention;

FIG. 2 is a partial exploded view of the damp-proof pill box in FIG. 1; and

FIGS. 3 and 4 are operational sectional views of the damp-proof pill box in FIG. 1, showing different operating statuses of the damp-proof pill box.

### DETAILED DESCRIPTION OF THE PREFERRED EMBODIMENTS

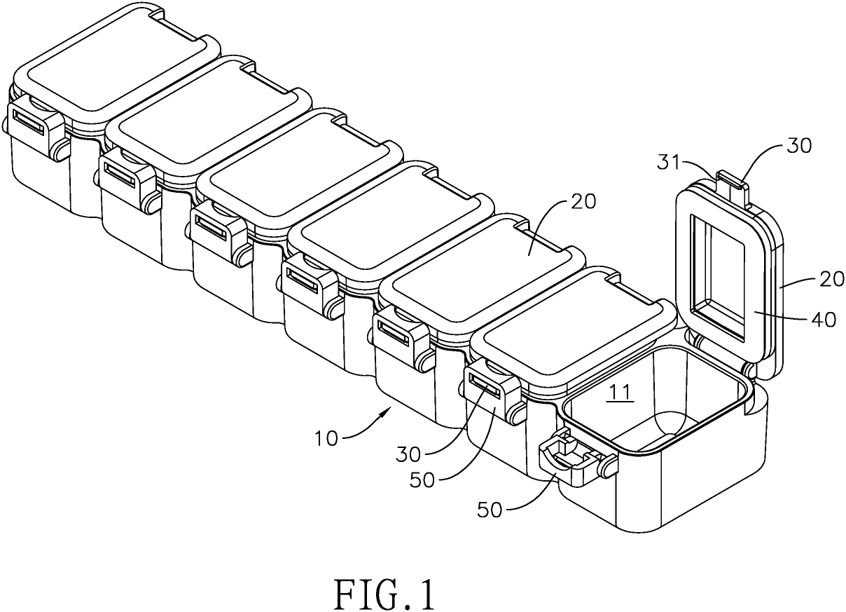

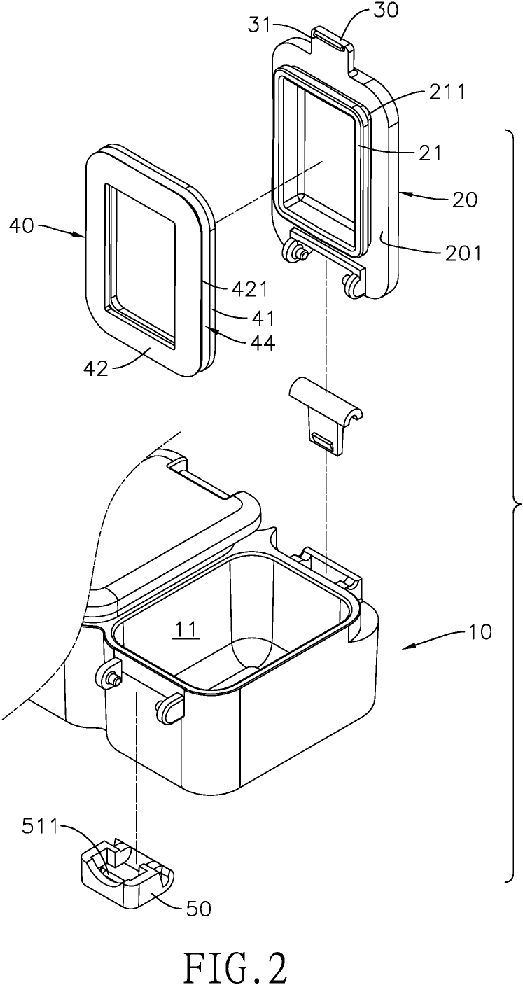

With reference to FIGS. 1 to 3, a damp-proof pill box in accordance with the present invention comprises a container 10, multiple lids 20, multiple lock tabs 30, multiple seal rings 40, and multiple lock parts 50

The container 10 forms multiple storage compartments 11, each of the storage compartments 11 has an opening. A user may organize medications into the different storage compartments 11 based on type and timing of dosage. In another preferred embodiment, the container 10 has only one storage compartment 11, and the numbers of the lid 20, the lock tab 30, the seal ring 40, and the lock part 50 are one.

The lids 20 are connected to the container 10. Each of the lids 20 is flippable relative to the container 10 to cover or to open a respective one of the storage compartments 11.

Each of the lids 20 has a lid-inner surface 201 facing toward a respective one of the storage compartments 11. In the preferred embodiment, each of the lids 20 has an annular mounting portion 21 and an annular mounting groove 211. The annular mounting portion 21 protrudes from the lid-inner surface 201, and the annular mounting groove 211 is formed in an outer annular surface of the annular mounting portion 21.

Each of the lock tabs 30 protrudes from an edge of a respective one of the lids 20 and preferably has a tab engaging portion 31 formed on a surface of the lock tab 30. The tab engaging portion 31 preferably protrudes from said surface of the lock tab 30 and is preferably disposed on a bottom surface of the lock tab 30.

Each of the seal rings 40 is mounted on the lid-inner surface 201 of a respective one of the lids 20. Each seal ring 40 is disposed along a periphery of the respective lid 20; in other words, an annular contour of each seal ring 40 is substantially same as the annular periphery of the respective lid 20 in terms of shape.

Each of the seal rings 40 is selectively clamped between the respective lid 20 and the container 10, and is configured to abut against a periphery of the opening of a respective one of the storage compartments 11 to seal said storage compartment 11. As a result, the seal rings 40 prevent any possible gap between the container 10 and the lids 20, thereby sealing the storage compartments 11. The seal rings 40 are preferably made of an elastic material.

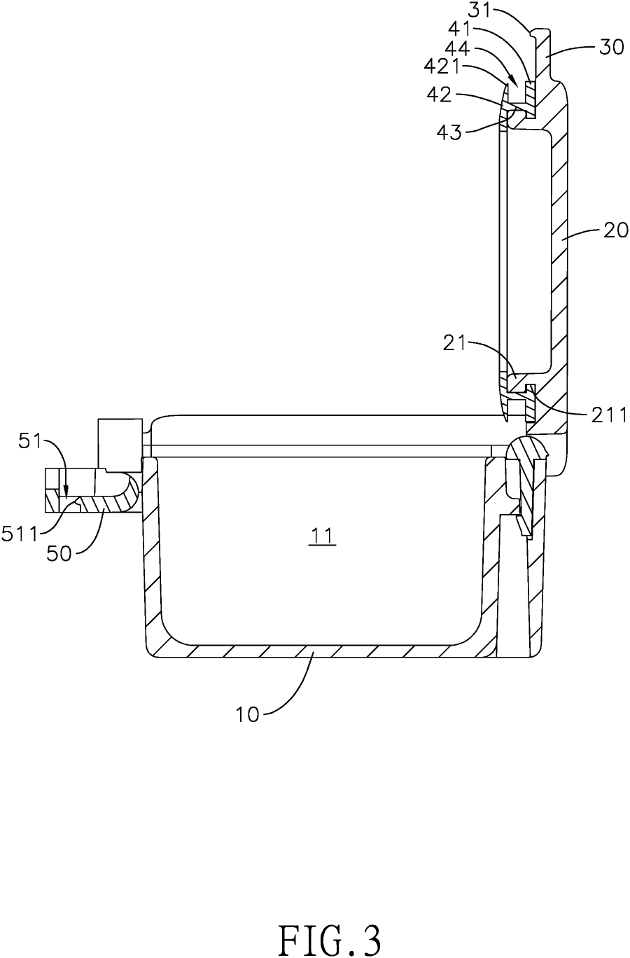

In the preferred embodiment, each of the seal rings 40 has an upper seal piece 41, a lower seal piece 42, and a connecting portion 43 (as shown in FIG. 3). The upper seal piece 41, the lower seal piece 42, and the connecting portion 43 are all annular in shape.

The upper seal piece 41 is selectively clamped between the respective lid 20 and the container 10. The upper seal piece 41 engages in the annular mounting groove 211 of the respective lid 20 such that the seal ring 40 can be detached from the respective lid 20, but configurations of the seal rings are not limited thereto.

The lower seal piece 42 is disposed apart from the upper seal piece 41. To be specific, an annular contour of the lower seal piece 42 is substantially same as an annular contour of the upper seal piece 41, and the lower seal piece 42 is parallel to the upper seal piece 41. In the preferred embodiment, thickness of the lower seal piece 42 gradually reduces toward an outer annular edge 421 thereof such that the outer annular edge 421 is more elastically deformable to conform to other objects. As a result, the lower seal piece 42 improves sealing efficacy of the pill box.

The connecting portion 43 is connected between the upper seal piece 41 and the lower seal piece 42. An annular seal recess 44 is formed between the upper seal piece 41 and the lower seal piece 42, and surrounds the connecting portion 43. In other words, the upper seal piece 41 and the lower seal piece 42 each form a respective one of two opposite side walls of the annular seal recess 44, while the connecting portion 43 forms a bottom of the annular seal recess 44. An opening of the annular seal recess 44 is orientated away from a center of the seal ring 40.

Each of the lock parts 50 is pivotally connected to the container 10, and corresponds in position to a respective one of the lock tabs 30. When one of the lids 20 covers the respective storage compartment 11, the lock tab 30 protruded from said lid 20 selectively engages with the corresponding lock part 50. To be specific, said lock part 50 is pivotal toward said lock tab 30 to engage with said lock tab 30, or said lock part 50 is pivotal away from said lock tab 30 to disengage with said lock tab 30.

In the preferred embodiment, each of the lock parts 50 has a lock recess 51 (as shown in FIG. 3) formed in the lock part. The lock recess 51 is formed in an inner surface of the lock part 50 and forms an opening on an outer surface of the lock part 50, making the lock recess 51 a through hole in the lock part 50, but configuration of the lock recess 51 is not limited thereto.

Moreover, a recess engaging portion 511 is formed in one of the side walls of the lock recess 51. When the lock part 50 engages with the corresponding lock tab 30, the recess engaging portion 511 engages with the tab engaging portion 31 of the lock tab 30 to securely engage the lock part 50 with the corresponding lock tab 30.

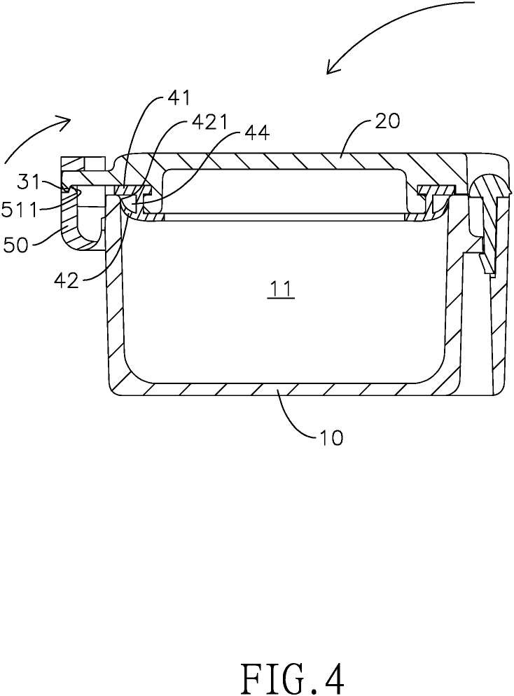

With reference to FIGS. 3 and 4, when one of the lids 20 is flipped away from the container 10 to open the respective storage compartment 11 (as shown in FIG. 3), the upper seal piece 41 and the lower seal piece 42 of the respective seal ring 40 are substantially parallel to each other.

When said lid 20 is flipped toward the container 10 to close the respective storage compartment 11 (as shown in FIG. 4), the upper seal piece 41 is clamped between the container 10 and said lid 20, and the upper seal piece 41 abuts against the periphery of the opening of the respective storage compartment 11 to act as first layer of seal. Meanwhile, the lower seal piece 42 is disposed in the respective storage compartment 11, and the outer annular edge 421 abuts against an inner surface of said storage compartment 11 such that the opening of the annular seal recess 44 is sealed by the inner surface of the storage compartment 11 to form a sealed annular space, which acts as second layer of seal.

When the storage compartments 11 are covered by the lid 20, moisture from the surroundings is blocked by the first layer of seal formed by the upper seal piece 41 and therefore cannot enter the storage compartments 11. Even if minute amount of moisture breaks through the first layer of seal, the break-through-moisture will be blocked by the second layer of seal formed by the annular seal recess 44, thereby preventing moisture from entering into the storage compartment 11 and effectively preventing medications stored inside the storage compartment 11 from deteriorating due to exposure to moisture.

In summary, when the storage compartments 11 are covered by the lids 20, the seal rings 40 are clamped between the lids 20 and the container 10, and the seal rings 40 abut against the peripheries of the openings of the storage compartments 11 to prevent moisture from the surroundings to enter into the storage compartments 11, thereby preventing medications stored in the storage compartments 11 from exposure to moisture.

Moreover, when the storage compartments 11 are covered by the lids 20, the lock parts 50 are capable of engaging with the lock tabs 30 to firmly clamp the seal rings 40 from opposite directions, ensuring that the damp-proof pill box is tightly sealed from moisture.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A damp-proof pill box comprising:
a container forming at least one storage compartment; each of the at least one storage compartment having an opening;
at least one lid connected to the container and being flippable relative to the container to cover or to open the at least one storage compartment; each of the at least one lid having a lid-inner surface facing toward a respective one of the at least one storage compartment;
at least one lock tab, and each of the at least one lock tab protruding from an edge of a respective one of the at least one lid;
at least one seal ring, and each of the at least one seal ring mounted on the lid-inner surface of a respective one of the at least one lid; and
at least one lock part pivotally connected to the container;
wherein when the at least one lid covers the at least one storage compartment, the at least one seal ring is clamped between the at least one lid and the container, and abuts against at least one periphery defined around the at least one opening of the at least one storage compartment to seal the at least one storage compartment; the at least one lock part selectively engages with the at least one lock tab to prevent the at least one lid from flipping relative to the container.

2. The damp-proof pill box as claimed in claim 1, wherein each of the
at least one seal ring has
an upper seal piece being annular and selectively clamped between the container and the at least one lid;
a lower seal piece being annular and resilient, and disposed apart from the upper seal piece;
a connecting portion being annular and connected between the upper seal piece and the lower seal piece; and
an annular seal recess formed between the upper seal piece and the lower seal piece, and surrounding the connecting portion;
wherein the upper seal piece and the lower seal piece each form a respective one of two opposite side walls of the annular seal recess;
wherein when the at least one lid covers the at least one storage compartment, the at least one upper seal piece of the at least one seal ring is clamped between the container and the at least one lid, and abuts against the at least one periphery defined around the at least one opening of the at least one storage compartment; the at least one lower seal piece of the at least one seal ring is disposed in the at least one storage compartment, and an outer annular edge of each of the at least one lower seal piece abuts against an inner surface of a respective one of the at least one storage compartment; an opening of the annular seal recess is sealed by the inner surface of the at least one storage compartment to form a sealed annular space.

3. The damp-proof pill box as claimed in claim 2, wherein thickness of the lower seal piece of each of the at least one seal ring gradually reduces toward the outer annular edge of the lower seal piece.

4. The damp-proof pill box as claimed in claim 1, wherein
each of the at least one lid has
an annular mounting portion protruding from the lid-inner surface; and
an annular mounting groove formed in an outer annular surface of the annular mounting portion;
each of the at least one seal ring engages in the annular mounting groove of a respective one of the at least one lid.

5. The damp-proof pill box as claimed in claim 3, wherein
each of the at least one lid has
an annular mounting portion protruding from the lid-inner surface; and
an annular mounting groove formed in an outer annular surface of the annular mounting portion;
each of the at least one seal ring engages in the annular mounting groove of a respective one of the at least one lid.

6. The damp-proof pill box as claimed in claim 1, wherein
each of the at least one lock tab has a tab engaging portion formed on a surface of the lock tab; and
each of the at least one lock part has a lock recess formed in the lock part; a recess engaging portion is formed in a side wall of the lock recess;
when the at least one lock part engages with the at least one lock tab, the at least one lock tab is mounted in the lock recess, and the recess engaging portion engages with the tab engaging portion.

7. The damp-proof pill box as claimed in claim 5, wherein
each of the at least one lock tab has a tab engaging portion formed on a surface of the lock tab; and
each of the at least one lock part has a lock recess formed in the lock part; a recess engaging portion is formed in a side wall of the lock recess;
when the at least one lock part engages with the at least one lock tab, the at least one lock tab is mounted in the lock recess, and the recess engaging portion engages with the tab engaging portion.

8. The damp-proof pill box as claimed in claim 6, wherein the tab engaging portion of each of the at least one lock tab is disposed on a bottom surface of the lock tab.
